(19) United States
(12) Patent Application Publication
(10) Pub. No.: US 2007/0057619 A1
(43) Pub. Date: Mar. 15, 2007

(54) FIELD EMISSION LUMINESCENT DEVICE

(75) Inventors: Lin-En Chou, Hsinchu (TW); Bing-Nan Lin, Hsinchu (TW); Chuan-Hsu Fu, Hsinchu (TW)

Correspondence Address: Allen, Dyer, Doppelt, Milbrath & Gilchrist, P.A.;Suite 1401, 255 South Orange Avenue, Orlando, FL, 32801, US

(73) Assignee: Industrial Technology Research Institute, Hsinchu (TW)

(21) Appl. No.: 11/531,438

(22) Filed: Sep. 13, 2006

(30) Foreign Application Priority Data
Sep. 14, 2005 (TW) 94131734

(51) Int. Cl. H01J 63/00

(52) U.S. Cl. 313/495; 313/113

(57) ABSTRACT

A reflection-type field emission luminescent device is provided. The field emission luminescent device includes a cathode plate having an electron-emitting source formed thereon for emitting an electron beam, an anode plate including a first side having thereon an anode electrode layer and a fluorescence layer and a second side having thereon a reflection layer, and a vacuum formation structure formed between the cathode plate and the anode plate, in which the electron-emitting source, the anode electrode layer and the fluorescence layer are arranged. With the structure of the reflection-type field emission luminescent device, the electron beam generated from the cathode electrode plate is drawn by the anode plate and rams into the fluorescence layer for generating an emitted light in response to a collision of the electron beam to the fluorescence layer, and brightness of the emitted light is further enhanced through the reflection of the reflection layer

### FIELD OF THE INVENTION

The present invention relates to a luminescent device, and in particular to a flat luminescent device made of field emission device.

### BACKGROUND OF THE INVENTION

As the rapid developments of the optoelectronic products, the applications of the flat luminescence are more and more popular. Generally, the flat luminescence is known to be widely used for the flat panel display, the illumination application, and the indication application etc. However, most of the typical flat luminescent devices are constructed from the non-flat lighting source incorporated with a plurality of purposeful optical components. For example, the flat luminescence of the back light module for the liquid crystal display (LCD) is mainly formed by a strip-shaped cold cathode fluorescent lamp (CCFL) incorporated with a plurality of purposeful optical components, such as the light guide plate, the brightness enhancement film and the light diffusion film for converting the striped light into the flat luminescence. However, with the incorporation of such purposeful optical components, the intensity of the light will be sequentially decreased by each of the purposeful optical components when passing through or reflecting from those optical components. Therefore, the traditional flat luminescent devices not only have the problem in complicated assembly of the expensive optical components, but also have the trouble in brightness degradation.

Recently, due to the rapid development of the LCD TV, the demand for the flat luminescence is also increased rapidly. However, the display quality of the LCD TV is usually constrained by the brightness degradation of the flat luminescent device. In addition, the design of the thin type LCD TV is also constrained by the complicated assembly of the traditional flat luminescent device. Accordingly, it is necessary to develop a novel thin type flat luminescent device with higher brightness and lower power consumption for the LCD TV. It is well known that the field emission luminescent device is one of the promising flat luminescent devices that could be widely used for LCD TV. Comparing with the traditional flat luminescent device constructed by the strip-shaped CCFL, the field emission luminescent device not only has a thinner and simpler structural design, but also has the advantages in higher brightness and lower power consumption. Furthermore, the field emission luminescent device is not only applicable for the LCD as the backlight module but also suitable for the lighting system, the decoration light, and indication light.

Although the field emission luminescence has been developed for a long time, it also has some issues that should be overcome before being mass manufactured. First, the manufacturing process of the field emission luminescent device could be very elaborate and costly if it is carried out through the semiconductor process. Second, when the field emission luminescent device operates, the light generated by collision of the electron beam in the fluorescence layer of the field emission luminescent device is always accompanied with the generation of heat, which may cause an additional thermal issue of the field emission luminescent device.

Please refer to FIG. 1, which schematically shows a structure of a field emission luminescent device according to the prior art. As shown in FIG. 1, the field emission luminescent device 100′ includes an anode plate 10′ and a cathode plate 20′ which are arranged in parallel. The anode plate 10′ is formed by a transparent substrate 12′, such as the glass substrate, an anode electrode layer 14′ and a fluorescence layer 16′, while the cathode plate 20′ is formed by a further transparent substrate 22′ and a cathode electrode layer 24′. In a typical design, the cathode electrode layer 24′ further has an electron-emitting source (not shown) for emitting an electron beam e- and a gate electrode layer (not shown) for increasing the density of the electron beam e-, while the anode electrode layer 14′ is used for drawing the electron beam e- to ram into the fluorescence layer 16′, in order to generate an emitted light in response to the collision of the electron beam e-. With such a field emission luminescent device 100′, the brightness of the emitted light could be enhanced by increasing the density of the electron beam e-. However, when the density of the electron beam e- is increased, the heat caused by the collision of the electron beam e- to the fluorescence layer 16′ will also be rapidly increased. Accordingly, a thermal issue, relating to the thermal expansion (or deformation) of the anode plate 10′, could happen. Therefore, it might be necessary to develop a further way to enhance the brightness the field emission luminescent device, with which the thermal issues caused from the enhanced brightness the field emission luminescent device could be easily prevented.

### SUMMARY OF THE INVENTION

It is a first aspect of the present invention to provide a novel field emission luminescent device. The field emission luminescent device includes a cathode plate having an electron-emitting source formed thereon for emitting an electron beam, an anode plate including a first side having thereon an anode electrode layer and a fluorescence layer and a second side having thereon a reflection layer, and a vacuum formation structure formed between the cathode plate and the anode plate, in which the electron-emitting source, the anode electrode layer and the fluorescence layer are arranged.

It is a second aspect of the present invention to provide a further field emission luminescent device which includes a first substrate having an electron-emitting source formed thereon for emitting an electron beam, and an second substrate including a first side facing to the first substrate and having thereon an electrode layer and a fluorescence layer and a second side having thereon a reflection layer.

It is a third aspect of the invention to provide a novel method for manufacturing a field emission luminescent device. The manufacturing method includes at least the following steps of (a) providing an anode and a cathode pieces, (b) forming a cathode electrode layer on the cathode piece, (c) sequentially forming an anode electrode layer and a fluorescence layer on one side of the anode piece, and (d) forming a reflection layer on another side of the anode piece.

Preferably, the reflection layer is formed by a deposition process.

Preferably, the deposition process is one selected from a group consisting of a sputtering process, an electroplating process, an electroless deposition process, a vapor deposition process and the combination thereof.

Preferably, the reflection layer is formed by a bonding process.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram schematically illustrating a field emission luminescent device according to the prior art;

FIG. 2 is a diagram schematically illustrating a reflection-type field emission luminescent device according to an preferred embodiment of the present invention;

FIG. 3(A) is a diagram schematically illustrating the emitted light paths of the conventional field emission luminescent device;

FIG. 3(B) is a diagram schematically illustrating the emitted light paths of the reflection-type field emission luminescent device according to the preferred embodiment of the present invention;

FIG. 4 is a diagram illustrating the manufacturing processes of the reflection-type field emission luminescent device according to the preferred embodiment of the present invention.

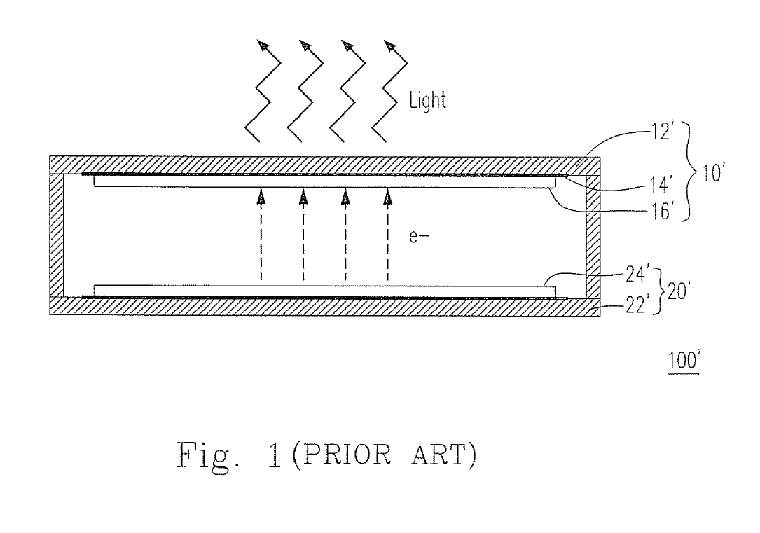

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

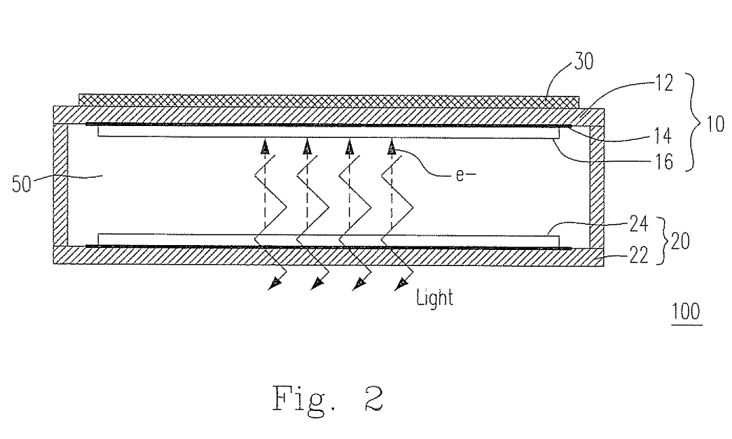

Please refer to FIG. 2, which shows a reflection-type field emission luminescent device according to a preferred embodiment of the present invention. As shown in FIG. 2, the field emission luminescent device 100 has an anode plate 10 and a cathode plate 20, between which a space is vacuum packaged, so that a vacuum formation structure 50 is formed therebetween. Furthermore, the anode plate 10 further includes a substrate 12 having an anode electrode layer 14 and a fluorescence layer 16 formed in the vacuum side of the anode plate 10 and a reflection layer 30 formed on the opposite side thereof. The cathode plate 20 includes a substrate 22 having a cathode electrode layer 24 in the vacuum side as the electron-emitting source for emitting an electron beam. When field emission luminescent device 100 operates, the anode electrode layer 14 and the cathode electrode layer 24 are applied with a positive and a negative voltage respectively, so that an electron beam e- generated from the cathode electrode layer 24 is drawn by the positive voltage applied on the anode electrode layer 14 and rams into the fluorescence layer 16 for generating an emitted light in response to a collision of the electron beam e- to the fluorescence layer 16.

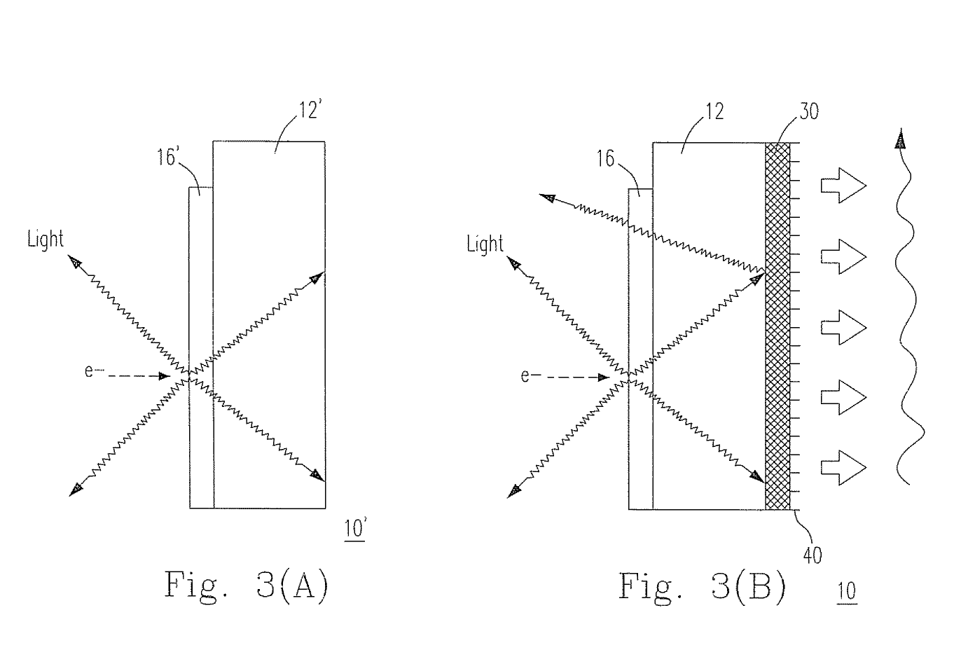

Please further refer to FIGS. 3(A) and 3(B), which respectively show the transmission paths of the emitted lights in the conventional field emission luminescent device and the reflection-type field emission luminescent device according to the present invention. As shown in FIG. 3(A), when an electron beam e- coming from the cathode plate is drawn by the anode electrode layer (not shown) in the anode plate 10′ and rams into the fluorescence layer 16′, an emitted light in response of the collision of the electron beam to the fluorescence layer 16′ is generated and transmitted non-directionally. Since the emitted light is non-directional, only parts (the reflection parts of the transmission parts) of the emitted light could contribute to the luminescence brightness of the field emission luminescent device, while the other parts of the emitted light have no any contribution to the luminescence brightness of the field emission luminescent device. On the other hand, as shown in FIG. 3(B), if an additional reflection layer 30 is mounted on the opposite the anode plate, the emitted light passing through the substrate 12 of the anode plate can be reflected by the reflection layer 30, so that most of the emitted light could contribute to the brightness of the field emission luminescent device. Therefore, the reflection-type field emission luminescent device 100 according to the present invention has better lighting efficiency than the conventional field emission luminescent device has.

In a further preferred embodiment of the present invention, the anode plate 10 and the cathode plate 20 are pervious to light. Specifically, the substrates 12, 22 are transparent glass substrates. Moreover, the reflection layer 30 formed on the anode plate could be a metal layer having a relatively high reflection index, so that the power loss of the reflection light can be reduced. Meanwhile, the reflection layer 30 could also be a metal layer having a relatively high thermal conductivity and a relatively high coefficient of thermal expansion, so that the thermal issue and the thermal deformation of the anode plate can be abated. In a further preferred embodiment of the present invention, a heat dissipation device 40, such as the heat sink, the fan, or other cooling system might further be connected on the reflection layer 30, so as to improve the cooling efficiency of the anode plate.

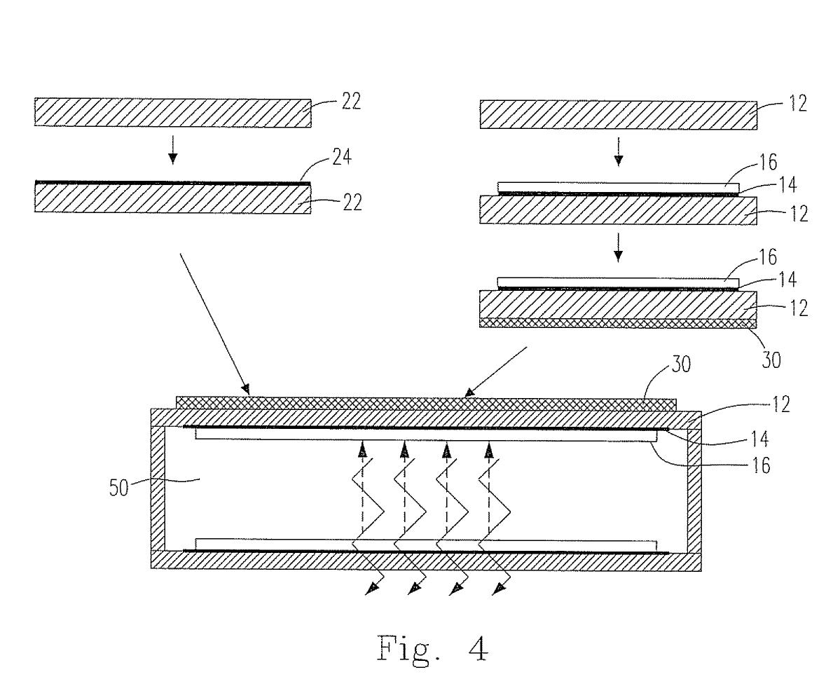

Please refer to FIG. 4, which schematically shows the manufacturing processes of the reflection-type field emission luminescent device according to the present invention. As shown in FIG. 4, the manufacturing method of the reflection-type field emission luminescent device includes the anode plate processes and the cathode plate processes. As to the cathode plate processes, a transparent substrate 22 is firstly provided. In the next step, a cathode electrode layer 24 is formed on the transparent substrate 22. As to the anode plate processes, a further transparent substrate 12 is provided. Next, an anode electrode layer 14 and a fluorescence layer 16 are sequentially formed on one side of the transparent substrate 12, and a reflection layer 30 is formed on the opposite side of the transparent substrate 12. After finishing the anode and the cathode plates processes, the anode and the cathode plate are then vacuum packaged in such a way that a vacuum formation structure 50 is formed therebetween and the anode electrode layer 14, the fluorescence layer 16 and the cathode electrode layer 24 are arranged therewithin.

In a preferred embodiment of the present invention, the reflection layer 30 is formed by a deposition process, such as a sputtering process, an electroplating process, and electroless deposition process or a vapor deposition process. Furthermore, the reflection layer 30 also could be formed by a bonding process.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A field emission luminescent device, comprising:
a cathode plate having an electron-emitting source formed thereon for emitting an electron beam;
an anode plate comprising:
a first side having thereon an anode electrode layer and a fluorescence layer; and
a second side having thereon a reflection layer; and
a vacuum formation structure formed between the cathode plate and the anode plate, in which the electron-emitting source, the anode electrode layer and the fluorescence layer are arranged;
wherein the electron beam is drawn by the anode electrode layer and rams into the fluorescence layer, and an emitted light in response to a collision of the electron beam is enhanced through a reflection of the reflection layer.

2. The field emission luminescent device according to claim 1, wherein the anode plate and the cathode plate are pervious to light.

3. The field emission luminescent device according to claim 1, wherein the reflection layer is a metal layer having a relatively high reflection index.

4. The field emission luminescent device according to claim 1, wherein the reflection layer is a metal layer having a relatively high thermal conductivity.

5. The field emission luminescent device according to claim 1, further comprising a heat sink connected to the reflection layer.

6. The field emission luminescent device according to claim 1, wherein the reflection layer has a relatively high coefficient of thermal expansion for abating a thermal deformation of the anode plate.

7. A field emission luminescent device, comprising:
a first substrate having an electron-emitting source formed thereon for emitting an electron beam; and
an second substrate comprising:
a first side facing to the first substrate and having thereon an electrode layer and a fluorescence layer; and
a second side having thereon a reflection layer;
wherein the electron beam is drawn by the electrode layer for ramming into the fluorescence layer, and an emitted light in response to a collision of the electron beam is enhanced through a reflection of the reflection layer.

8. The field emission luminescent device according to claim 7, wherein the second substrates are glass substrates with transparent electrode.

9. The field emission luminescent device according to claim 7, wherein the reflection layer is a metal layer having a relatively high reflection index.

10. The field emission luminescent device according to claim 7, wherein the reflection layer is a metal layer having a relatively high thermal conductivity.

11. The field emission luminescent device according to claim 7, further comprising a heat sink connected to the reflection layer.

12. The field emission luminescent device according to claim 7, wherein the reflection layer has a relatively high coefficient of thermal expansion for abating a thermal deformation of the first substrate.

13. A method for manufacturing a field emission luminescent device, comprising:
providing an anode and a cathode pieces;
forming a cathode electrode layer on the cathode piece;
sequentially forming an anode electrode layer and a fluorescence layer on one side of the anode piece; and
forming a reflection layer on another side of the anode piece.

14. The method according to claim 13, wherein the reflection layer is formed by a deposition process.

15. The method according to claim 14, wherein the deposition process is one selected from a group consisting of a sputtering process, an electrodplating process, an electroless deposition process, a vapor deposition process and the combination thereof.

16. The method according to claim 13, wherein the reflection layer is formed by a bonding process.
